(19) United States
(12) Patent Application Publication
(10) Pub. No.: US 2012/0019719 A1
(43) Pub. Date: Jan. 26, 2012

(54) DIGITAL TELEVISION BROADCASTING REPRODUCTION DEVICE AND REPRODUCTION METHOD THEREFOR

(75) Inventors: Yasuhiro TAKESUE, Osaka (JP); Takaharu MOROHASHI, Osaka (JP); Koji NAKAJIMA, Kyoto (JP)

(73) Assignee: PANASONIC CORPORATION, Osaka (JP)

(21) Appl. No.: 13/251,479

(22) Filed: Oct. 3, 2011

Related U.S. Application Data
(63) Continuation of application No. PCT/JP2010/001017, filed on Feb. 18, 2011.

(30) Foreign Application Priority Data
Apr. 8, 2009 (JP) 2009-094360

(51) Int. Cl. H04N 5/445; H04N 5/06

(52) U.S. Cl. 348/521; 348/564; 348/E05.099; 348/E05.011

(57) ABSTRACT

A second video encoded buffer stores encoded data of a second channel at time of a single display. A buffer control unit specifies, at time of a switching from the single display to a simultaneous display, a key frame which is a start frame for decoding in the encoded data of the second channel and has a time stamp, which is earlier than a broadcasting time of the encoded data and also is closest to the broadcasting time. Moreover, the buffer control unit generates decoded data by decoding the encoded data of the second channel stored in the second encoded buffer from the specified key frame. A second video decoding unit and a second video output unit start a reproduction of the decoded data when the time stamp is synchronized with the broadcasting time.

### CROSS REFERENCE TO RELATED APPLICATION

This is a continuation application of PCT application No. PCT/JP2010/001017 filed on Feb. 18, 2010, designating the United States of America.

### BACKGROUND OF THE INVENTION

(1) Field of the Invention

The present invention relates to a digital television broadcasting reproduction device and a reproduction method therefor which can reduce time required for switching a channel of digital television broadcasting.

(2) Description of the Related Art

In Japan, there is one segment broadcasting as digital television broadcasting for mobile terminals. The one segment broadcasting is based on ISDB-T (Integrated Services Digital Broadcasting for Terrestrial) system, which is a standard of terrestrial digital television broadcasting in Japan. In the ISDB-T, each channel (6 MHz bandwidth) is composed of thirteen segments. Twelve of the thirteen segments are used for stationary reception broadcasting directed to a receiving apparatus which is fixedly installed in a standard home etc., and the remaining one segment is used for the one segment broadcasting directed to a mobile equipment such as a mobile phone, a receiving apparatus mounted on a vehicle, or the like. After 2011, a service based on a system of ISDB-Tmm (Integrated Services Digital Broadcasting-Terrestrial for mobile multimedia) or MediaFLO (Forward Link Only) will be started as a next-generation digital television broadcasting for mobile terminals (being considered mainly by Japan Ministry of Internal Affairs and Communications, refer to “ISDB-Tmm system”, Document 16-3-1, by Ad Hoc Group 1, Broadcasting System Committee (16^{th} Meeting), Telecommunications Technology Subcounsil, Telecommunications Counsil of Japan Ministry of Internal Affairs and Communications and “MediaFLO”, Document 16-3-2, by Ad Hoc Group 2, Broadcasting System Committee (16^{th} Meeting), Telecommunications Technology Subcounsil, Telecommunications Counsil of Japan Ministry of Internal Affairs and Communications). The ISDB-Tmm system has features that a boundary of each segment is removed and digital television broadcasting signals can be received for each segment independently. It also has a feature that segments can be connected together so as to have an arbitrary bandwidth and transmitted (refer to “NIKKEI ELECTRONICS 2008.1.14”, pp. 126 to 136, published by Nikkei Business Publications, Inc., for example). The ISDB-Tmm system enables multichannel reproduction in which a segment allocated for one channel is further divided and multiple-program broadcasting in which plural programs are broadcast on one channel. The ISDB-Tmm system enables a reception of plural channels with a single tuner which is installed in a mobile phone. That is to say, the multichannel reproduction can be achieved with a low-cost configuration.

As for the multichannel reproduction, a digital television reproduction device is equipped with a function of providing plural windows on a display screen of a television etc. and simultaneously reproducing different channels on different windows, respectively. FIG. 3 shows an example of a television screen of a digital television broadcasting reproduction device which achieves a simultaneous display of plural channels.

As shown in FIG. 3, while a channel is reproduced on a first screen, a different channel is simultaneously reproduced on a second screen, which is different from the first screen. In this type of digital television broadcasting reproduction device, a channel is switched from a single display of the first channel on the first screen to a simultaneous display of the first and second channels on the first and second screens, respectively (for example, refer to Japanese Unexamined Patent Application Publication No. 2006-295974).

FIG. 14 is a block diagram showing a functional configuration of a conventional digital television broadcasting reproduction device. An operation to switch the channel is described with reference to FIG. 14. The digital television broadcasting reproduction device in FIG. 14 includes a TS parser 1403, a microcomputer 1404, a video decoding unit 1407, and an audio decoding unit 1406.

The TS parser 1403 extracts a packet identifier (PID) of a transport stream (TS) which includes video and audio of a channel selected by a user. After storing the extracted PID in a memory 1405, the microcomputer 1404 sets the stored PID in the TS parser 1403. The video decoding unit 1407 and the audio decoding unit 1406 use the set PID and decode the video and the audio outputted from the TS parser 1403, respectively.

When a desired channel is selected by the user, the microcomputer 1404 determines whether or not a PID of video and audio which correspond to the selected channel is stored in the memory 1405. When determining that the PID is stored in the memory 1405, the microcomputer 1404 sets the PID in the TS parser 1403. The video decoding unit 1407 and the audio decoding unit 1406 use the PID which is set in the TS parser 1403 and decode the video and the audio which correspond to the channel selected by the user, respectively.

### SUMMARY OF THE INVENTION

However, the above conventional digital television broadcasting reproduction device has a problem described below when the channel is switched from the single display of the first channel on the first screen to the simultaneous display of the first and second channels on the first and second screens, respectively, as shown in FIG. 3.

The problem to be solved by the present invention is described using FIG. 15. FIG. 15 is a graph showing a transition of the switching from the single display of the first channel on the first screen to the simultaneous display of the first and second channels on the first and second screens, respectively. A horizontal axis indicates an actual time, and a vertical axis indicates a time indicated by a presentation time stamp (PTS), which is reproduction time information. FIG. 15 shows a case of synchronizing a picture of video with a newest broadcasting time and outputting the picture at a predetermined time interval.

In a period Y1, the first channel is singly displayed on the first screen. Subsequently, at a time X1, the single display of the first channel on the first screen is switched to the simultaneous display of the first and second channels on the first and second screens. A decoding is started from a key frame (also referred to as an intra-coded picture or a reference frame) of the second channel on the second screen at the time X1, and a difference value between the PTS of the key frame and the broadcasting time at the time X1 is calculated. The key frame of the second channel on the second screen is delayed for a period Y2, which is the calculated difference value, and subsequently displayed from a time X2 which is synchronized with a newest broadcasting time. Here, the key frame is a start frame for decoding.

As described above, with the conventional configuration, when the single display of the first channel on the first screen is switched to the simultaneous display of the first and second channels on the first and second screens, the decoding processing and the resynchronization processing of the frame occur from the key frame in the second channel on the second screen which is added to the first screen. Thus, there is a problem that a time lag occurs after the operation to switch the single display to the simultaneous display is executed before the second channel is displayed. For example, with the conventional configuration, when there is a key frame interval of two to five seconds (as a one segment operation example), the second channel is not displayed for two to five seconds in a worst-case situation after the operation of switching to the simultaneous display.

The present invention is to solve the above problem, and an object of the present invention is to provide a digital television broadcasting reproduction device which minimizes a time lag which occurs before the second channel is displayed when the single display of the first channel on the first screen is switched to the simultaneous display of the first and second channels on the first and second screens.

To solve the above problem, the digital television broadcasting reproduction device according to one aspect of the present invention that has a dual-screen reproducing function for realizing a single display to reproduce a digital television broadcasting on a first channel and a simultaneous display to reproduce the digital television broadcasting on both the first channel and a second channel, the digital television broadcasting reproduction device includes: a first decoding reproduction unit which generates decoded data by decoding encoded data of the first channel and reproduces the generated decoded data; a second decoding reproduction unit which generates decoded data by decoding encoded data of the second channel and reproduces the generated decoded data; an encoded buffer which stores the encoded data of the second channel at time of the single display; a memory which stores a time stamp which corresponds to a key frame being a start frame for decoding in the encoded data of the second channel stored in the encoded buffer; a broadcasting time generation unit which sequentially generates a broadcasting time of encoded data; and a buffer control unit which transfers the encoded data of the second channel stored in the encoded buffer to the second decoding reproduction unit only at time of the simultaneous display, and the buffer control unit specifies, at time of a switching from the single display to the simultaneous display, a key frame of a second channel having a time stamp, which is earlier than a broadcasting time at the time of the switching and also is closest to the broadcasting time at the time of the switching, by reference to the memory and sequentially transfers the encoded data, starting with the encoded data of the specified key frame, of the second channel which is stored in the encoded buffer to the second decoding reproduction unit, and the second decoding reproduction unit starts decoding of the encoded data of the second channel from the specified key frame and starts reproducing the decoded data when a time stamp is synchronized with a newest broadcasting time.

With this configuration, the encoded data of the second channel is stored in the encoded buffer even at the time of single display. Moreover, when the single display is switched to the simultaneous display, the decoded data of the second channel starts to be decoded from the key frame having the time stamp, which is earlier than the broadcasting time at the time of switching and also is closest to the broadcasting time at the time of switching, and the reproduction of the decoded data is started when the time stamp is synchronized with the newest broadcasting time. Thus, the time between the switching and the start of display of the second channel can be reduced.

It is preferable that the buffer control unit further calculates, at the time of the switching from the single display to the simultaneous display, a difference value between the time stamp of the specified key frame and the broadcasting time at the time of the switching, and the second decoding reproduction unit reproduces the generated decoded data while synchronizing a new broadcasting time, which is obtained by adding the difference value to the broadcasting time which is sequentially generated by the broadcasting time generation unit, with a time stamp.

With this configuration, when the channel which has not been displayed is displayed in the multichannel reproduction, the difference between the time stamp of the key frame retained in the memory and the broadcasting time at the time of switching to the simultaneous display is added to the broadcasting time, which is sequentially generated by the broadcasting time generation unit, as the offset, so that the immediate display from the key frame can be achieved.

It is also preferable that the memory further stores a time stamp corresponding to a non-key frame which is the encoded data of the second channel except a key frame, and the buffer control unit specifies, at time of a switching from the single display to the simultaneous display, a key frame having a time stamp which is earlier than a broadcasting time at the time of the switching and also is closest to the broadcasting time at the time of the switching, and a non-key frame having a time stamp which is earlier than a broadcasting time at the time of the switching and also is closest to the broadcasting time at the time of the switching, by reference to the memory and (1) when a total number of frames between the specified key frame and the specified non-key frame is less than a certain value, the encoded data, starting with the encoded data of the specified key frame, of the second channel stored in the encoded buffer are sequentially transferred to the second decoding reproduction unit, and (2) when a total number of frames between the specified key frame and the specified non-key frame is equal to or more than a certain value, the encoded data, starting with the encoded data of a key frame having a time stamp which is later than a broadcasting time at the time of the switching and also is closest to the broadcasting time at the time of the switching, of the second channel stored in the encoded buffer are sequentially transferred to the second decoding reproduction unit.

With this configuration, when it is determined that there are the large number of frames between the key frame and the non-key frame synchronized with the broadcasting time at the time of switching to the simultaneous display and thus it takes time to execute the decoding processing from the key frame to the non-key frame which is synchronized with the broadcasting time, the decoding processing can be started from the key frame of the encoded data of the second channel which is synchronized with the newest broadcasting time, and consequently, the time lag which occurs at the time of switching can be reduced.

It is also preferable that the present invention is achieved as an integrated circuit. One example of the integrated circuit is LSI.

Moreover, the present invention can be achieved not only as the digital television broadcasting reproduction device having the above features but also as a mobile phone provided with the above digital television broadcasting reproduction device to obtain similar actions and effects.

Furthermore, the present invention can be achieved not only as the digital television broadcasting reproduction device having the above characteristic means but also as a digital television broadcasting reproduction method having steps of the above characteristic means included in the digital television broadcasting reproduction device and as a program which causes a computer to execute the above characteristic steps included in the digital television broadcasting reproduction method. The above program can be distributed via a recording medium such as CD-ROM (Compact Disc-Read Only Memory) etc. and a communication network such as Internet etc.

The present invention makes it possible to minimize a time lag which occurs before the second channel is displayed when the single display of the first channel on the first screen is switched to the simultaneous display of the first and second channels on the first and second screens.

### FURTHER INFORMATION ABOUT TECHNICAL BACKGROUND TO THIS APPLICATION

The disclosure of Japanese Patent Application No. 2009-094360 filed on Apr. 8, 2009 including specification, drawings and claims is incorporated herein by reference in its entirety.

The disclosure of PCT application No. PCT/JP2010/001017 filed on Feb. 18, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram illustrating a functional configuration of a digital television broadcasting reproduction device according to Embodiment 1 of the present invention;

FIG. 2 is a diagram illustrating a relationship between patterns of channel switch signals and television screen displays according to Embodiment 1 of the present invention;

FIG. 3 is a diagram illustrating an image of a digital television broadcasting reproduction device having two screens according to Embodiment 1 of the present invention;

FIG. 4 is a diagram for describing a correction of STC (system time clock) according to Embodiment 1 of the present invention;

FIG. 5 is an operational flow chart of a buffer control unit according to Embodiment 1 of the present invention;

FIG. 6 is a configuration diagram of a memory according to Embodiment 1 of the present invention;

FIG. 7 is an operational flow chart of a switching from a single display of a first channel on a first screen to a simultaneous display of first and second channels on first and second screens, respectively, according to Embodiment 1 of the present invention;

FIG. 8 is a diagram for describing a relationship of the switching from the single display of the first channel on the first screen to the simultaneous display of first and second channels on first and second screens according to Embodiment 1 of the present invention;

FIG. 9 is a block diagram illustrating a functional configuration of a digital television broadcasting reproduction device according to Modification 1 of Embodiment 1 of the present invention;

FIG. 10 is an operational flow chart of a switching from a single display of a first channel on a first screen to a simultaneous display of first and second channels on first and second screens according to Modification 1 of Embodiment 1 of the present invention;

FIG. 11 is a diagram for describing a relationship of the switching from the single display of the first channel on the first screen to the simultaneous display of the first and second channels on the first and second screens according to Modification 1 of Embodiment 1 of the present invention;

FIG. 12 is a configuration diagram of a memory according to Modification 2 of Embodiment 1 of the present invention;

FIG. 13 is a block diagram illustrating a whole configuration of a mobile phone to which the present invention is applied as Embodiment 2 of a digital television broadcasting reproduction device according to the present invention;

FIG. 14 is a block diagram illustrating a functional configuration of a digital television broadcasting reproduction device of a conventional technique; and

FIG. 15 is a diagram for describing a first problem in the conventional technique.

### DESCRIPTION OF THE PREFERRED EMBODIMENTS

### Embodiment 1

Embodiment 1 of the present invention is described below in detail with reference to drawings.

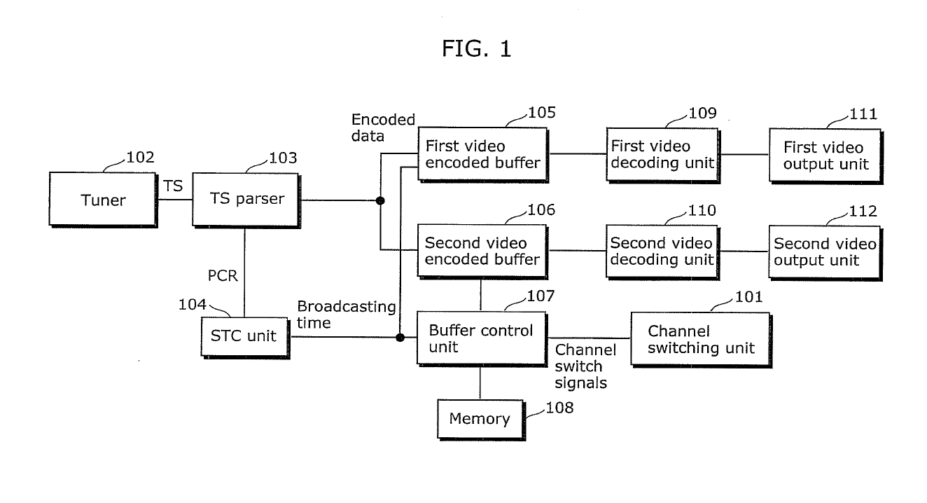

FIG. 1 is a block diagram illustrating a functional configuration of a digital television broadcasting reproduction device according to Embodiment 1 of the present invention. The digital television broadcasting reproduction device in FIG. 1 includes a channel switching unit 101, a tuner 102, a TS parser 103, a STC unit 104, a first video encoded buffer 105, a second video encoded buffer 106, a buffer control unit 107, a memory 108, a first video decoding unit 109, a second video decoding unit 110, a first video output unit 111, and a second video output unit 112.

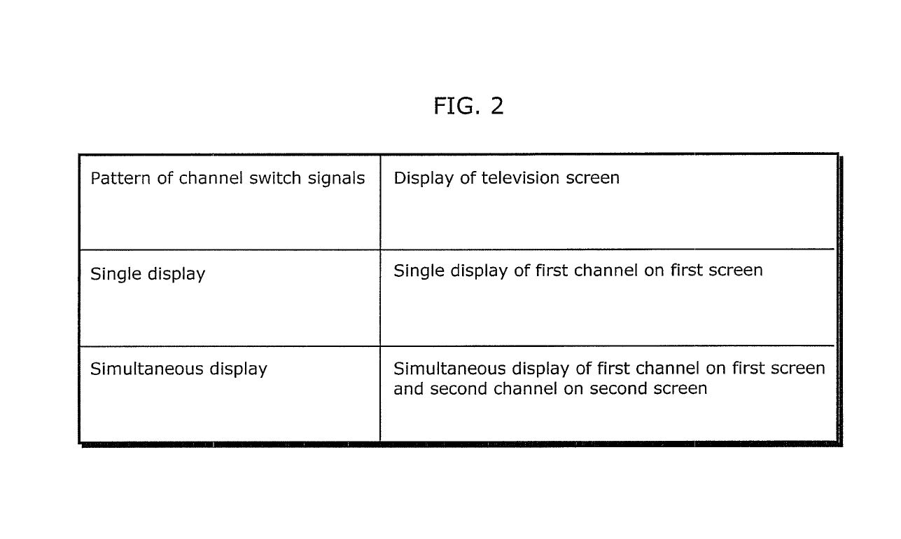

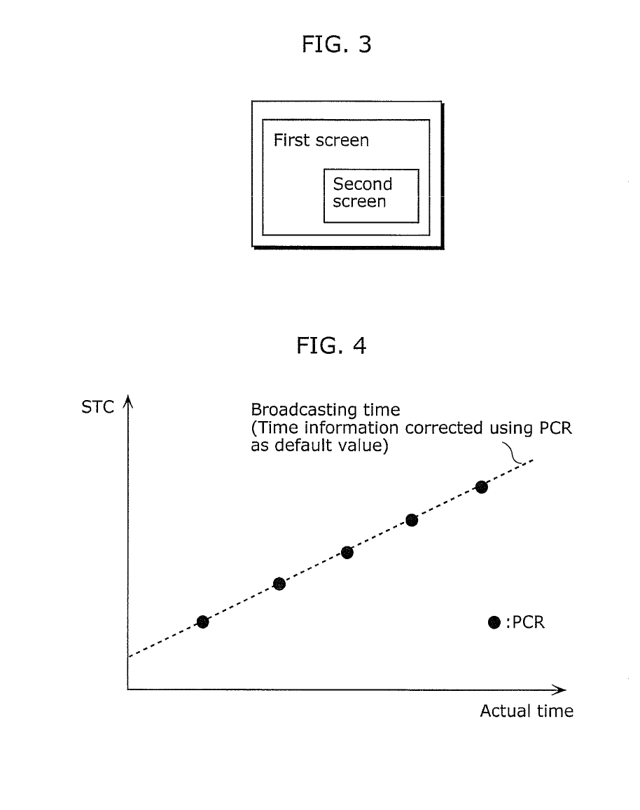

The channel switching unit 101 receives a command to switch a channel on a television screen from a user and transmits channel switch signals to the buffer control unit 107. Patterns of the channel switch signals are shown in FIG. 2. FIG. 2 shows a pattern of reproducing two screens in a multichannel reproduction of a first channel and a second channel. When the pattern of the channel switch signals indicates a single display, the television screen displays singly the first channel on a first screen. When the pattern of the channel switch signals indicates a simultaneous display, the television screen displays simultaneously the first channel on the first screen and the second channel on a second screen as shown in FIG. 3. As shown in FIG. 2, there are two patterns of television screen display, thus there are two patterns of channel switch signals transmitted to the buffer control unit 107, that is, the single display and the simultaneous display.

The tuner 102 receives and demodulates digital television broadcasting signals. The digital television broadcasting reproduction device obtains a transport stream (TS) from the demodulated signals. In a multichannel system, the TS includes plural channels. A configuration which includes the two channels, that is, the first channel and the second channel, is described in Embodiment 1. The tuner 102 transfers the TS to the TS parser 103.

The TS parser 103 demultiplexes a packetized elementary stream (PES) from the TS and extracts encoded data of video and audio from the PES. In the multichannel system, the PES includes the plural encoded data of video and audio. In Embodiment 1, the PES which includes video encoded data of two channels is described. A header of the PES includes a presentation time stamp (PTS) as a time stamp of reproduction time information. The TS parser 103 associates video encoded data of the first channel which is extracted from the TS with the PTS and transfers the video encoded data to the first video encoded buffer 105. The TS parser 103 also associates video encoded data of the second channel which is extracted from the TS with the PTS and transfers the video encoded data to the second video encoded buffer 106.

The TS includes a program clock reference (PCR) which is current broadcasting time information. The TS parser 103 transfers the PCR to the STC unit 104.

The STC unit 104 generates a STC (system time clock: hereinafter referred to as the broadcasting time) of the digital television broadcasting in the digital television broadcasting reproduction device. The broadcasting time is counted with a period of 27 MHz, for example, using a value of the PCR, which is transferred from the TS parser 103 at predetermined time intervals, as a default value and is corrected based on the time information of the PCR. FIG. 4 is a graph for describing a correction of broadcasting time. In FIG. 4, a horizontal axis indicates an actual time and a vertical axis indicates a broadcasting time. FIG. 4 shows an example of correcting linearly the broadcasting time using the PCR value which is transferred at predetermined time intervals as the default value.

Embodiment 1 of the present invention is described with reference to the block diagram of FIG. 1 again.

The first video encoded buffer 105 is a buffer which buffers the video encoded data of the first channel and the PTS which corresponds to the video encoded data. The buffer control unit 107 synchronizes the video encoded data stored in the first video encoded buffer 105 with the broadcasting time generated by the STC unit 104 and transfers the video encoded data to the first video decoding unit 109 sequentially. That is to say, in order to synchronize the video encoded data with the broadcasting time, the buffer control unit 107 calculates a difference value between the newest broadcasting time obtained from the STC unit 104 and the PTS of the video encoded data stored in the first video encoded buffer 105 and controls the transfer of the video encoded data to keep the difference value within a threshold value.

The second video encoded buffer 106 is a buffer which buffers the video encoded data of the second channel and the PTS which corresponds to the video encoded data. The buffer control unit 107 synchronizes the video encoded data stored in the second video encoded buffer 106 with the broadcasting time generated by the STC unit 104 and transfers the video encoded data to the second video decoding unit 110 sequentially. That is to say, in order to synchronize the video encoded data with the broadcasting time, the buffer control unit 107 calculates a difference value between the newest broadcasting time obtained from the STC unit 104 and the PTS of the video encoded data stored in the second video encoded buffer 106 and controls the transfer of the video encoded data to keep the difference value within a threshold value.

The first video encoded buffer 105 and the second video encoded buffer 106 accumulate the encoded data in advance of the broadcasting time, have a large-capacity buffer to prevent a buffer overflow, and controls a writing of new data over old data sequentially.

The first video decoding unit 109 decodes the video encoded data of the first channel and transfers the decoded data of the first channel to the first video output unit 111.

The second video decoding unit 110 decodes the video encoded data of the second channel and transfers the decoded data of the second channel to the second video output unit 112.

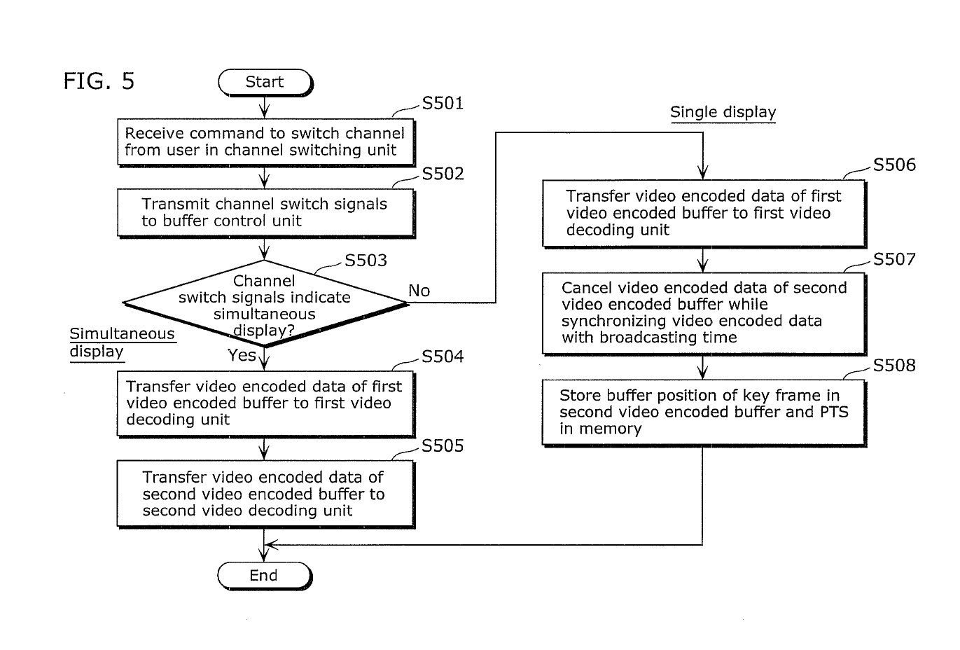

An operation of the buffer control unit 107 changes in accordance with the pattern of the channel switch signals transmitted from the channel switching unit 101 shown in FIG. 2. FIG. 5 is an operational flow chart of the buffer control unit 107. The operation of the buffer control unit 107 is described using FIG. 5.

At first, the channel switching unit 101 receives the command to switch the channel from the user (S501). The channel switching unit 101 transmits the channel switch signals of the pattern in FIG. 2 to the buffer control unit 107 (S502). The buffer control unit 107 determines whether or not the pattern of the channel switch signals indicates the simultaneous display. When determining that the pattern of the channel switch signals indicates the simultaneous display (Yes in S503), the buffer control unit 107 transfers the video encoded data of the first channel, which is stored in the first video encoded buffer 105, to the first video decoding unit 109 while synchronizing the PTS which corresponds to the video encoded data with the broadcasting time generated by the STC unit 104 (S504). The buffer control unit 107 transfers the video encoded data of the second channel, which is stored in the second video encoded buffer 106, to the second video decoding unit 110 while synchronizing the PTS which corresponds to the video encoded data with the broadcasting time generated by the STC unit 104 (S505).

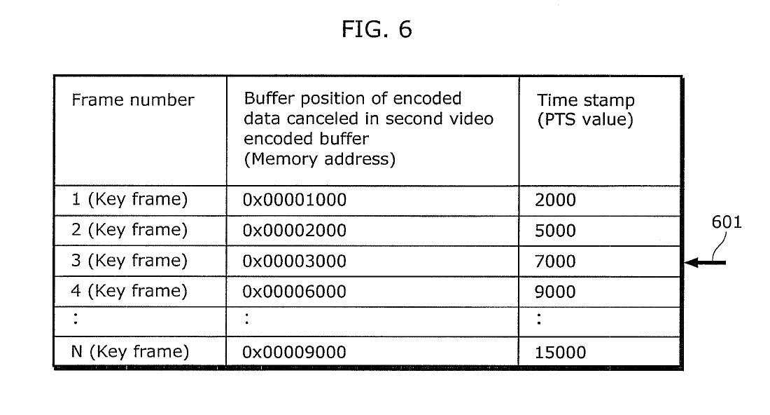

When determining that the pattern of the channel switch signals indicates the single display (No in S503), the buffer control unit 107 transfers the video encoded data of the first channel, which is stored in the first video encoded buffer 105, to the first video decoding unit 109 while synchronizing the PTS which corresponds to the video encoded data with the broadcasting time generated by the STC unit 104 (S506). The buffer control unit 107 cancels the video encoded data of the second channel, which is stored in the second video encoded buffer 106, while synchronizing the PTS which corresponds to the video encoded data with the broadcasting time generated by the STC unit 104 (S507). Here, the cancel of the video encoded data does not mean that the video encoded data is deleted but it means that the video encoded data is not transmitted to the second video decoding unit 110 which decodes the video encoded data in the subsequent step. At the same time, the buffer control unit 107 stores a buffer position of a key frame (intra-coded picture), whose video encoded data of the second channel is canceled, in the second video encoded buffer 106 and the PTS which corresponds to the key frame in the memory 108 (S508). The memory 108 stores data having a configuration as shown in FIG. 6. That is to say, the memory 108 stores the buffer positions of the key frames in the second video encoded buffer 106 and the PTS as the time stamp corresponding to the key frames, respectively, in accordance with the number of frames. FIG. 6 shows that information of key frames are stored in accordance with N numbers of frames. The buffer position in the second video encoded buffer 106 is an address of the second video encoded buffer 106. The memory 108 has enough capacity to store the frames whose numbers correspond to a capacity of the second video encoded buffer 106. Moreover, the memory 108 controls a writing of new data over old data sequentially. An operation flow of the buffer control unit 107 to switch the single display of the first channel on the first screen to the simultaneous display of the first and second channels on the first and second screens, respectively is described below.

The first video output unit 111 outputs the decoded data of the first channel which is transferred from the first video decoding unit 109 while synchronizing the PTS with the broadcasting time generated by the STC unit 104.

The second video output unit 112 outputs the decoded data of the second channel which is transferred from the second video decoding unit 110 while synchronizing the PTS with the broadcasting time generated by the STC unit 104.

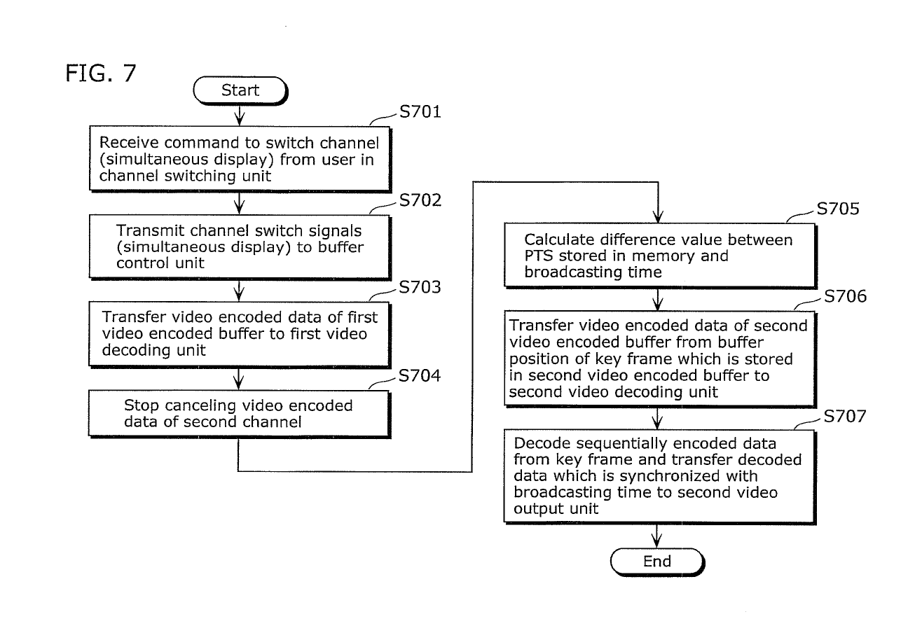

The operation to switch the single display of the first channel on the first screen to the simultaneous display of the first and second channels on the first and second screens is described below. FIG. 7 is an operational flow chart of the switching from the single display of the first channel on the first screen to the simultaneous display of the first and second channels on the first and second screens.

The channel switching unit 101 receives a command to switch a channel to a simultaneous display from a user (S701). With the step of S701, a switching from a single display to a simultaneous display occurs. The channel switching unit 101 transmits channel switch signals to switch the single display to the simultaneous display, shown in FIG. 2, to the buffer control unit 107 (S702). The buffer control unit 107 transfers video encoded data of the first channel, which is stored in the first video encoded buffer 105, to the first video decoding unit 109 while synchronizing a PTS which corresponds to the video encoded data with a broadcasting time generated by the STC unit 104 (S703). The buffer control unit 107 stops canceling the video encoded data of the second channel (S704). The buffer control unit 107 calculates a difference value between the PTS stored in the memory 108 and the broadcasting time at the time of switching to the simultaneous display generated by the STC unit 104 (S705). The buffer control unit 107 controls the second video encoded buffer 106 and transfers the video encoded data of the second channel from a buffer position of a key frame, which is stored in the second video encoded buffer 106 and has the smallest difference value and the PTS which is earlier than the broadcasting time at the time of switching, to the second video decoding unit 110 (S706). For example, when the broadcasting time at the time of switching is “8950”, the video encoded data of the second channel starts to be transferred to the second video decoding unit 110 from the encoded data of the key frame of a frame number 3 indicated by an arrow 601 in FIG. 6. The second video decoding unit 110 sequentially decodes the video encoded data of the second channel, which is transferred from the second video encoded buffer 106, from the key frame and starts transferring the decoded data, which is synchronized with the newest broadcasting time generated by the STC unit 104, to the second video output unit 112 (S707).

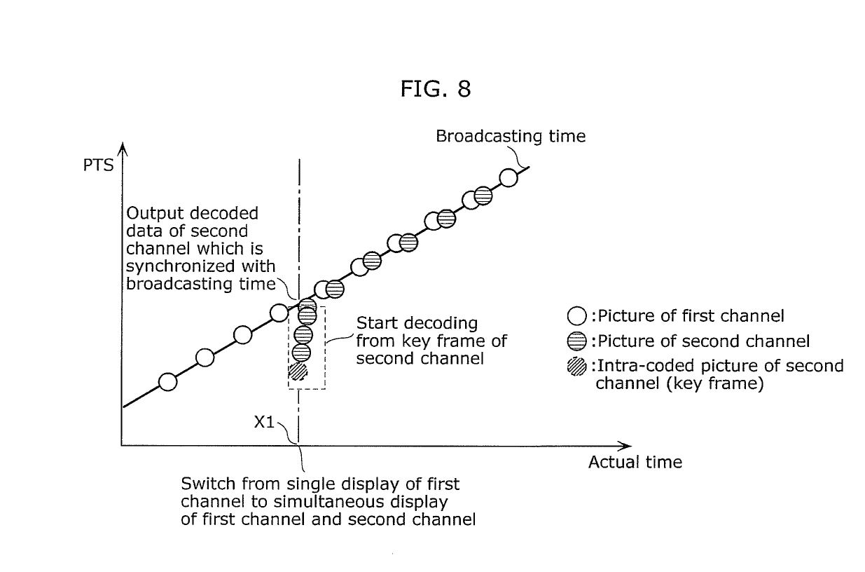

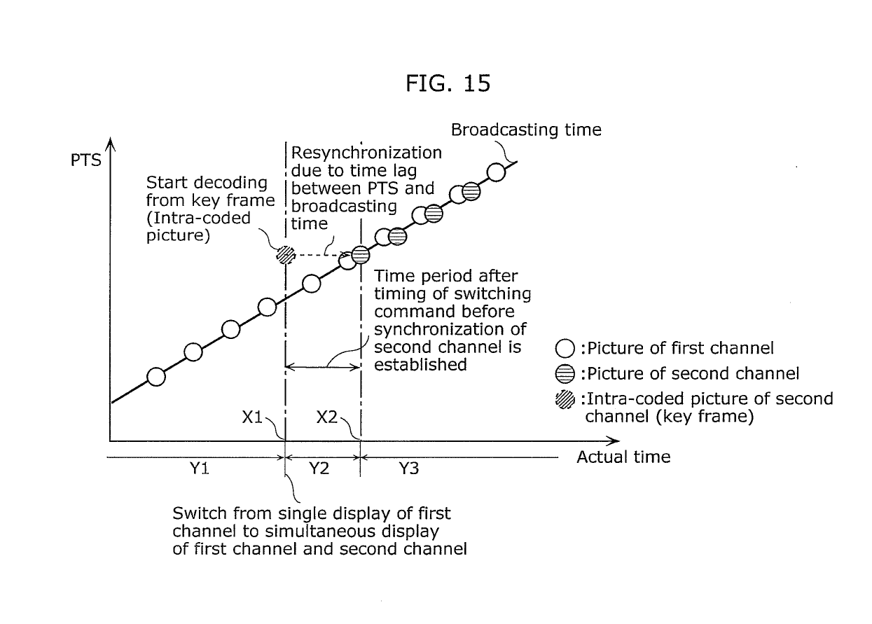

As described above, according to Embodiment 1, the encoded data of the second channel is stored in the second encoded buffer even at the time of single display. Moreover, when the single display is switched to the simultaneous display, the decoded data of the second channel starts to be decoded from the key frame having the time stamp, which is earlier than the broadcasting time at the time of switching and also is closest to the broadcasting time at the time of switching, and the reproduction of the decoded data is started when the time stamp is synchronized with the newest broadcasting time. Thus, the time between the switching and the start of display of the second channel can be reduced. That is to say, in the operation to switch the single display of the first channel on the first screen to the simultaneous display of the first and second channels on the first and second screens, a time lag which occurs at the time of switching from the single display to the simultaneous display is significantly reduced. Using FIG. 8 for description, when the single display is switched to the simultaneous display at a time X1, the key frame of the second channel starts to be decoded from the buffer position stored in the memory and the decoded data of the second channel which is synchronized with the newest broadcasting time is outputted immediately, so that the time lag which occurs at the time of switching is significantly reduced. Thus, the period Y2 described in the problem of FIG. 15 is shortened.

### Modification 1 of Embodiment 1

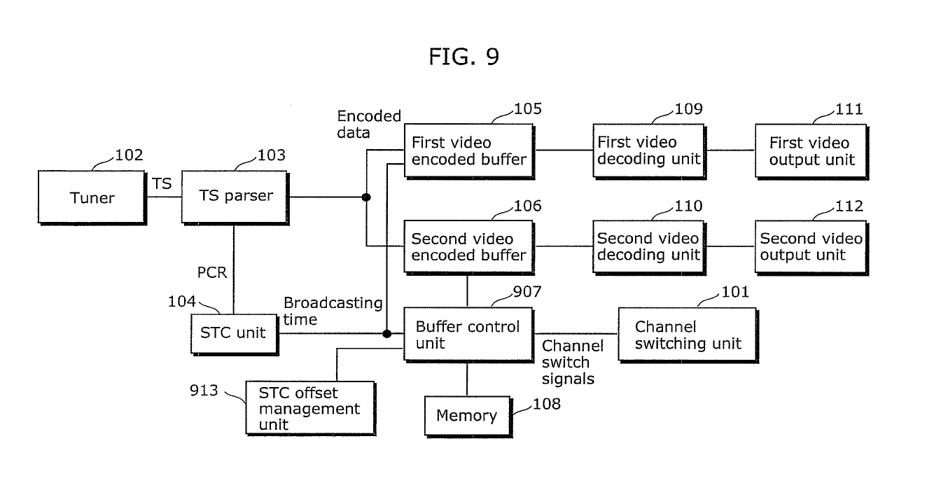

FIG. 9 is a block diagram illustrating a functional configuration of a digital television broadcasting reproduction device for describing Modification 1 of Embodiment 1 of the present invention. The digital television broadcasting reproduction device in FIG. 9 includes a channel switching unit 101, a tuner 102, a TS parser 103, a STC unit 104, a first video encoded buffer 105, a second video encoded buffer 106, a buffer control unit 907, a memory 108, a first video decoding unit 109, a second video decoding unit 110, a first video output unit 111, and a second video output unit 112. The block diagram of FIG. 9 differs from the block diagram of FIG. 1 in that a STC offset management unit 913 is added. Moreover, a processing executed by the buffer control unit 907 differs from the processing executed by the buffer control unit 107. The configuration which overlaps between FIGS. 1 and 9 is not repeatedly described here but the configuration which does not overlap is described below.

When a single display of a first channel on a first screen is switched to a simultaneous display of first and second channels on first and second screens, the buffer control unit 907 specifies a key frame which is stored in the second video encoded buffer 106, has a smallest difference value between a PTS of video encoded data of the second channel stored in the memory 108 and the broadcasting time at the time of switching to the simultaneous display, and has a PTS which is earlier than the broadcasting time at the time of switching. Moreover, the buffer control unit 907 calculates a difference value between the PTS of the specified key frame and the broadcasting time at the time of switching.

The STC offset management unit 913 retains the calculated difference value.

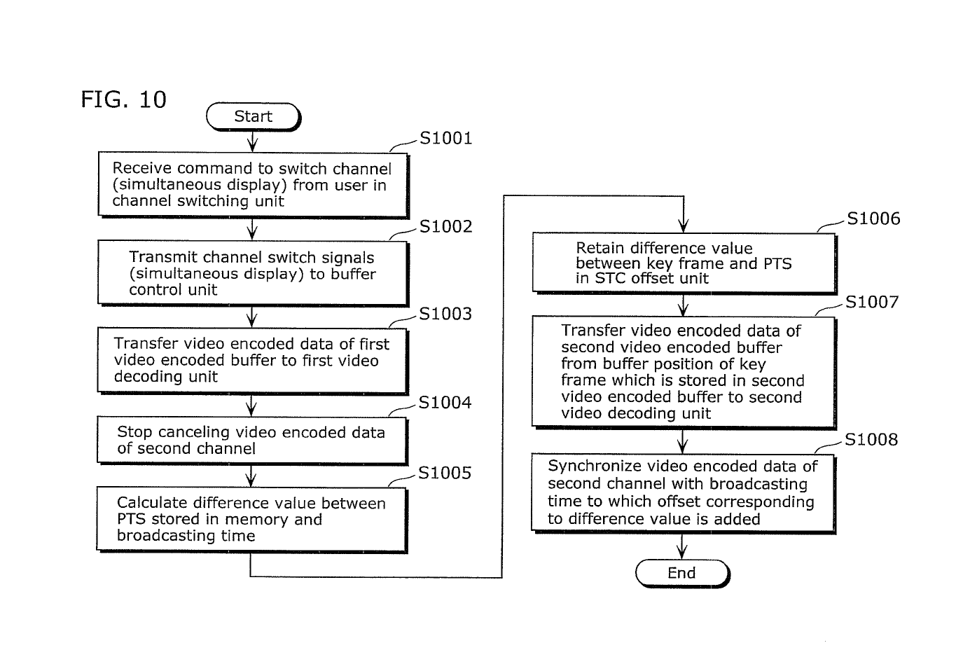

The operation to switch the single display of the first channel on the first screen to the simultaneous display of the first and second channels on the first and second screens is described below. FIG. 10 is an operational flow chart of the switching from the single display of the first channel on the first screen to the simultaneous display of the first and second channels on the first and second screens.

The channel switching unit 101 receives a command to switch a channel to a simultaneous display from a user (S1001). The channel switching unit 101 transmits channel switch signals to switch the single display to the simultaneous display, shown in FIG. 2, to the buffer control unit 907 (S1002). The buffer control unit 907 transfers video encoded data of the first channel, which is stored in the first video encoded buffer 105, to the first video decoding unit 109 while synchronizing a PTS which corresponds to the video encoded data with a newest broadcasting time generated by the STC unit 104 (S1003). The buffer control unit 907 stops canceling the video encoded data of the second channel (S1004). The buffer control unit 907 specifies the key frame which is stored in the second video encoded buffer 106, has the smallest difference value between the PTS of the video encoded data of the second channel stored in the memory 108 and the broadcasting time at the time of switching to the simultaneous display, and has the PTS which is earlier than the broadcasting time at the time of switching. Moreover, the buffer control unit 907 calculates the difference value between the PTS of the specified key frame and the broadcasting time at the time of switching (S1005). The STC offset management unit 913 retains the difference value between the PTS of the key frame and the broadcasting time at the time of switching, which is calculated in the step of S1005 (S1006). The buffer control unit 907 controls the second video encoded buffer 106 and transfers the video encoded data of the second channel from a buffer position of a key frame, which is stored in the second video encoded buffer 106 and has the smallest difference value and the PTS which is earlier than the broadcasting time at the time of switching, to the second video decoding unit 110 (S1007). For example, when the broadcasting time at the time of switching is “8950” in FIG. 6, the video encoded data of the second channel is transferred to the second video decoding unit 110 from the encoded data of the key frame of the frame number 3 indicated by the arrow 601. The second video output unit 112 adds an offset, which corresponds to the difference value which is retained in the STC offset management unit 913, to the newest broadcasting time generated by the STC unit 104 and outputs the decoded data of the second channel at the add time (S1008). Thus, the PTS of the decoded data of the second channel can be synchronized with the newest broadcasting time.

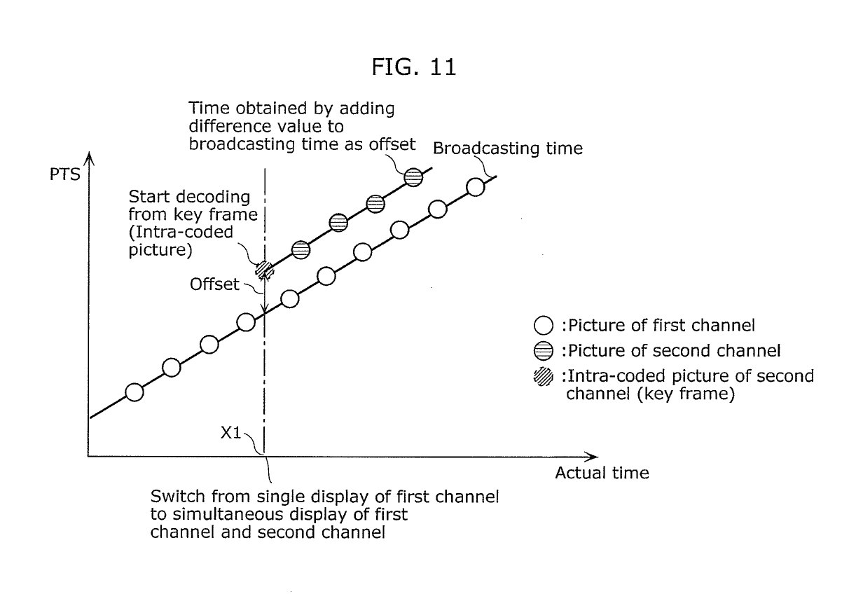

With the above operation, in Modification 1 of Embodiment 1, when the channel which has not been displayed is displayed in the multichannel reproduction, the difference between the time stamp of the key frame retained in the memory and the broadcasting time at the time of switching to the simultaneous display is added to the newest broadcasting time as the offset. This configuration enables the immediate display from the key frame. Consequently, in the operation to switch the single display of the first channel on the first screen to the simultaneous display of the first and second channels on the first and second screens, a time lag which occurs at the time of switching from the single display to the simultaneous display is significantly reduced. Using a graph of FIG. 11 for description, when the single display is switched to the simultaneous display at a time X1, the key frame of the second channel can be synchronized immediately by adding the difference between the time stamp and the broadcasting time to the newest broadcasting time of the second channel as the offset. Thus, the decoded data of the second channel which is synchronized with the newest broadcasting time can be outputted immediately, and the time lag which occurs at the time of switching is reduced.

### Modification 2 of Embodiment 1

A digital television broadcasting reproduction device for describing Modification 2 of Embodiment 1 of the present invention is described below. The digital television broadcasting reproduction device according to Modification 2 has a configuration similar to the digital television broadcasting reproduction device according to Embodiment 1 shown in FIG. 1. However, it differs from the block diagram of FIG. 1 in that a function of the buffer control unit 107 is added. Moreover, a processing executed by the buffer control unit 107 differs partially. The configuration which overlaps FIG. 1 is not repeatedly described here but the configuration which does not overlap is described below.

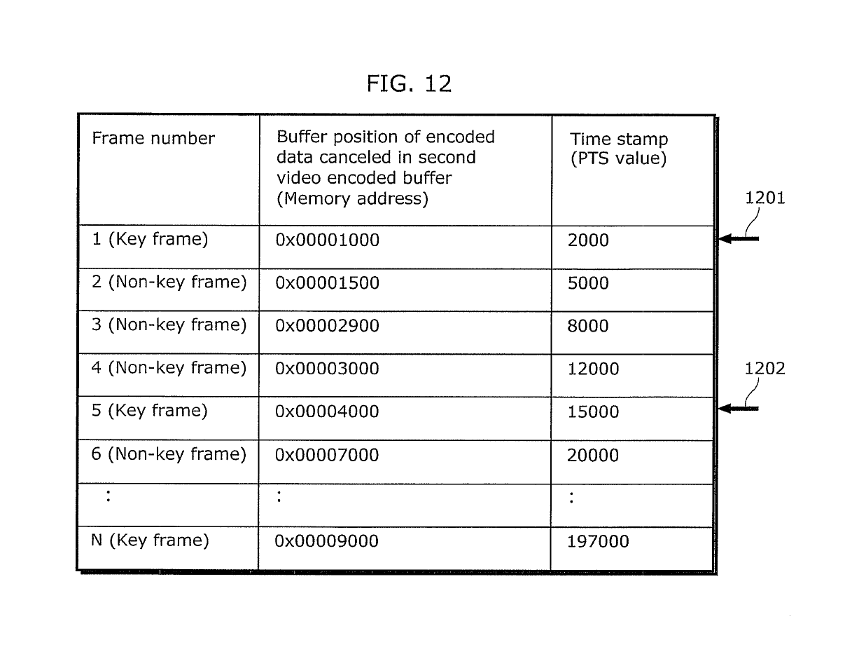

The buffer control unit 107 stores buffer positions in the second video encoded buffer 106 and a PTS which corresponds to frames in the memory 108 for key frames and non-key frames, whose video encoded data of the second channel are canceled in the single display, that is to say, all of the frames. In a configuration of FIG. 12, the memory 108 stores the buffer positions of the key frames and the non-key frames in the second video encoded buffer 106 and the PTS as the time stamp corresponding to the frames, respectively, in accordance with the number of frames. FIG. 12 shows that information of key frames and non-key frames are stored in accordance with N numbers of frames.

The operation to switch the single display of the first channel on the first screen to the simultaneous display of the first and second channels on the first and second screens is described below.

The buffer control unit 107 calculates the number of frames between the key frame, which has the smallest difference value between the PTS stored in the memory 108 and the broadcasting time at the time of switching to the simultaneous display and has the PTS which is earlier than the broadcasting time at the time of switching, which is generated by the STC unit 104, and the non-key frame, which has the smallest difference value between the PTS stored in the memory 108 and the broadcasting time at the time of switching and has the PTS which is earlier than the broadcasting time at the time of switching. The number of frames is calculated from the difference value between a non-key frame number and a key frame number. When the number of frames is less than a certain value, the buffer control unit 107 specifies a buffer position of a key frame which is stored in the second video encoded buffer 106, has the smallest difference value between the PTS stored in the memory 108 and the broadcasting time at the time of switching, and has the PTS which is earlier than the broadcasting time at the time of switching. The buffer control unit 107 transfers the encoded data from the specified buffer position to the second video encoded buffer 106. The second video encoded buffer 106 sequentially decodes the transferred encoded data. The second video output unit 112 sequentially displays the decoded data synchronized with the newest broadcasting time. For example, when the broadcasting time at the time of switching is “5500” in FIG. 12, the number of frames between the key frame (frame number 1) and the non-key frame (frame number 2) is “1”. When the number of frames “1” is determined to be less than the certain value, the encoded data, starting with the encoded data of the key frame of the frame number 1 indicated by an arrow 1201, are sequentially transferred to the second video decoding unit 110.

When the calculated number of frames is equal to or more than the certain value, the buffer control unit 107 specifies a buffer position of a key frame which is stored in the second video encoded buffer 106, has the smallest difference value between the PTS stored in the memory 108 and the broadcasting time at the time of switching, and has the PTS which is later than the broadcasting time at the time of switching. The buffer control unit 107 transfers the encoded data from the specified buffer position to the second video encoded buffer 106. The second video encoded buffer 106 sequentially decodes the transferred encoded data. The second video output unit 112 sequentially displays the decoded data synchronized with the newest broadcasting time. For example, when the newest broadcasting time is “14500” in FIG. 12, the number of frames between the key frame (frame number 1) and the non-key frame (frame number 4) is “3”. When the number of frames “3” is determined to be equal to or more than the certain value, the encoded data, starting with the encoded data of the key frame of the frame number 5 indicated by an arrow 1202, are sequentially transferred to the second video decoding unit 110.

As described above, in Modification 2 of Embodiment 1, when it is determined that there are the large number of frames between the key frame and the non-key frame synchronized with the broadcasting time at the time of switching to the simultaneous display and thus it takes time to execute the decoding processing in accordance with the above operation, the decoding processing can be started from the next key frame. Consequently, the time lag which occurs at the time of switching can be reduced. The above configuration is particularly effective when it takes time after the decoding processing of the key frame of the second channel is started before the decoded data which is synchronized with the newest broadcasting time is outputted in FIG. 8.

The above is the description of Embodiment 1.

The respective functional blocks such as the TS parser 103, the STC unit 104, the first video encoded buffer 105, the second video encoded buffer 106, the buffer control unit 107, the memory 108, the first video decoding unit 109, the second video decoding unit 110, etc. are typically achieved as LSI, which is an integrated circuit. Each of them may be made up of one chip individually. In the above description, the functional blocks are achieved as the LSI, however, the LSI is also referred to as IC, system LSI, super LSI, and ultra LSI in accordance with an integration degree.

Furthermore, when a technique of integrated circuit which replaces the LSI is produced due to a semiconductor technology advance or a different technique derived from the semiconductor technology advance, the functional block may naturally be integrated using the technique. There is a possibility of applying biotechnology, etc.

### Embodiment 2

Next, Embodiment 2 according to the present invention is described.

Embodiment 2 of the present invention describes a case of applying the digital television broadcasting reproduction device according to the present invention to a mobile phone.

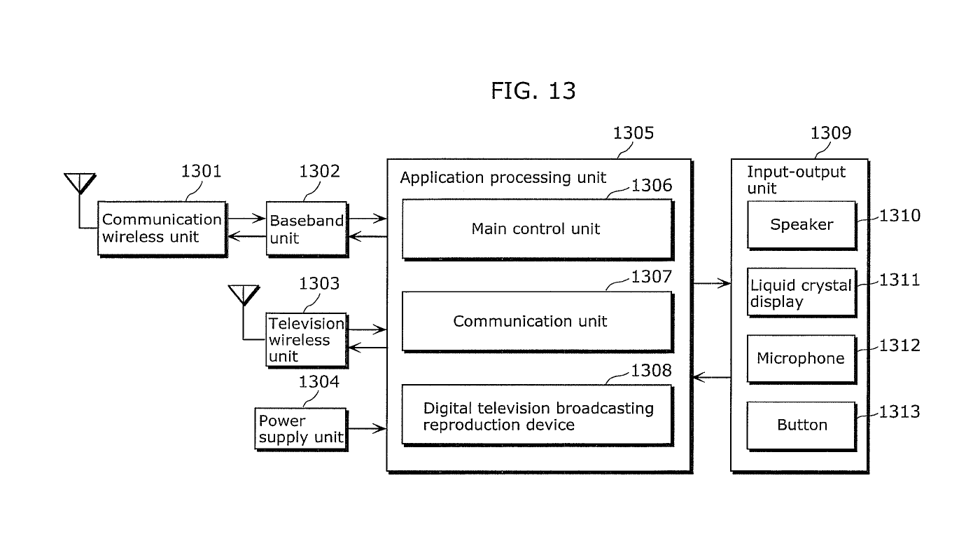

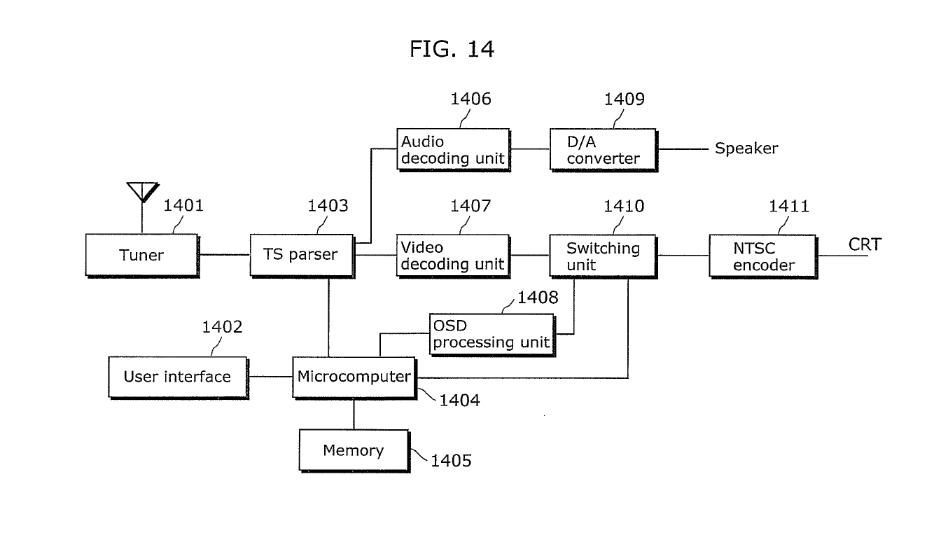

Embodiment 2 of the present invention is described below in detail with reference to FIG. 13.

FIG. 13 is a block diagram illustrating a whole configuration of a mobile phone to which the present invention is applied as an embodiment of a digital television broadcasting reproduction device according to the present invention. The mobile phone in Embodiment 2 includes a communication wireless unit 1301, a baseband unit 1302, a television wireless unit 1303 which receives digital television broadcasting signals, a power supply unit 1304, an application processing unit 1305 which executes various control, and an input-output unit 1309.

The communication wireless unit 1301 executes an external audio wireless communication processing. The baseband unit 1302 executes a baseband processing of wireless communication signals. The television wireless unit 1303 receives the digital television broadcasting signals and transmits data.

The application processing unit 1305 includes a main control unit 1306 which controls the whole mobile phone, a communication unit 1307 which controls the communication, and a digital television broadcasting reproduction device 1308 which has a configuration described in the above embodiment or modifications.

The input-output unit 1309 includes a speaker 1310 which outputs audio, a liquid crystal display 1311 which outputs video, a microphone 1312 which inputs the audio, and a button 1313 which achieves a key operation.

A function of the digital television broadcasting reproduction device 1308 of the present invention regarding the channel switching is described below using FIG. 13.

The digital television broadcasting signals are received by an antenna and inputted to the application processing unit 1305 via the television wireless unit 1303. In the application processing unit 1305, the inputted digital television broadcasting signals are inputted to the digital television broadcasting reproduction device 1308. The digital television broadcasting reproduction device 1308 decodes the digital television broadcasting signals and outputs video decoded data and audio decoded data to the input-output unit 1309. The video decoded data is outputted from the liquid crystal display 1311 and the audio decoded data is outputted from the speaker 1310. The channel is switched using the button 1313. The channel switching is equivalent to the channel switching unit 101 receiving the command to switch the channel from the user.

As described above, in the multichannel system, the digital television broadcasting reproduction device according to Embodiments of the present invention cancels the video encoded data of the channel which is not displayed, while synchronizing the PTS of the video encoded data with the newest broadcasting time, and also retains the buffer position of the key frame. Consequently, when the channel is displayed, the decoding can be started from the key frame, and the decoded data which is synchronized with the newest broadcasting time can be outputted immediately, so that the time lag which occurs at the time of switching is significantly reduced.

Although the digital television broadcasting reproduction device of the present invention is described based on Embodiments, the present invention not limited to those in Embodiments. The present invention also includes a modification of Embodiments conceivable by those skilled in the art and another embodiment obtained by combining any constituent elements according to Embodiments without materially departing from the novel teachings and advantages of the present invention.

Moreover, although the mobile phone which applies the digital television broadcasting reproduction device of the present invention is described as an embodiment, a scope of application of the digital television broadcasting reproduction device is not limited to it but can be applied to other equipments which can reproduce video and audio.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be used for a digital television broadcasting reproduction device and is useful in a television system for multichannel digital television broadcasting which simultaneously reproduces streams in which plural channels are multiplexed.

What is claimed is:

1. A digital television broadcasting reproduction device that has a dual-screen reproducing function for realizing a single display to reproduce a digital television broadcasting on a first channel and a simultaneous display to reproduce the digital television broadcasting on both the first channel and a second channel, said digital television broadcasting reproduction device comprising:
a first decoding reproduction unit configured to generate decoded data by decoding encoded data of the first channel and reproduce the generated decoded data;
a second decoding reproduction unit configured to generate decoded data by decoding encoded data of the second channel and reproduce the generated decoded data;
an encoded buffer which stores the encoded data of the second channel at time of the single display;
a memory which stores a time stamp which corresponds to a key frame being a start frame for decoding in the encoded data of the second channel stored in said encoded buffer;
a broadcasting time generation unit configured to sequentially generate a broadcasting time of encoded data; and
a buffer control unit configured to transfer the encoded data of the second channel stored in said encoded buffer to said second decoding reproduction unit only at time of the simultaneous display,
wherein said buffer control unit is configured to specify, at time of a switching from the single display to the simultaneous display, a key frame of a second channel having a time stamp, which is earlier than a broadcasting time at the time of the switching and also is closest to the broadcasting time at the time of the switching, by reference to said memory and sequentially transfer the encoded data, starting with the encoded data of the specified key frame, of the second channel which is stored in said encoded buffer to said second decoding reproduction unit, and
said second decoding reproduction unit is configured to start decoding of the encoded data of the second channel from the specified key frame and start reproducing the decoded data when a time stamp is synchronized with a newest broadcasting time.

2. The digital television broadcasting reproduction device according to claim 1,
wherein said buffer control unit is further configured to calculate, at the time of the switching from the single display to the simultaneous display, a difference value between the time stamp of the specified key frame and the broadcasting time at the time of the switching, and
said second decoding reproduction unit is configured to reproduce the generated decoded data while synchronizing a new broadcasting time, which is obtained by adding the difference value to the broadcasting time which is sequentially generated by said broadcasting time generation unit, with a time stamp.

3. The digital television broadcasting reproduction device according to claim 1,
wherein said memory further stores a time stamp corresponding to a non-key frame which is the encoded data of the second channel except a key frame, and
said buffer control unit is configured to specify, at time of a switching from the single display to the simultaneous display, a key frame having a time stamp which is earlier than a broadcasting time at the time of the switching and also is closest to the broadcasting time at the time of the switching, and a non-key frame having a time stamp which is earlier than a broadcasting time at the time of the switching and also is closest to the broadcasting time at the time of the switching, by reference to said memory and (1) when a total number of frames between the specified key frame and the specified non-key frame is less than a certain value, the encoded data, starting with the encoded data of the specified key frame, of the second channel stored in said encoded buffer are sequentially transferred to said second decoding reproduction unit, and (2) when a total number of frames between the specified key frame and the specified non-key frame is equal to or more than a certain value, the encoded data, starting with the encoded data of a key frame having a time stamp which is later than a broadcasting time at the time of the switching and also is closest to the broadcasting time at the time of the switching, of the second channel stored in said encoded buffer are sequentially transferred to said second decoding reproduction unit.

4. An integrated circuit that has a dual-screen reproducing function for realizing a single display to reproduce a digital television broadcasting on a first channel and a simultaneous display to reproduce the digital television broadcasting on both the first channel and the second channel, said integrated circuit comprising:
a first decoding reproduction unit configured to generate decoded data by decoding encoded data of the first channel and reproduce the generated decoded data;
a second decoding reproduction unit configured to generate decoded data by decoding encoded data of the second channel and reproduce the generated decoded data;
an encoded buffer which stores the encoded data of the second channel at time of the single display;
a memory which stores a time stamp which corresponds to a key frame being a start frame for decoding in the encoded data of the second channel stored in said encoded buffer;
a broadcasting time generation unit configured to sequentially generate a broadcasting time of encoded data; and
a buffer control unit configured to transfer the encoded data of the second channel stored in said encoded buffer to said second decoding reproduction unit only at time of the simultaneous display,
wherein said buffer control unit is configured to specify, at time of a switching from the single display to the simultaneous display, a key frame of a second channel having a time stamp, which is earlier than a broadcasting time at the time of the switching and also is closest to the broadcasting time at the time of the switching, by reference to said memory and sequentially transfer the encoded data, starting with the encoded data of the specified key frame, of the second channel which is stored in said encoded buffer to said second decoding reproduction unit, and
said second decoding reproduction unit is configured to start decoding of the encoded data of the second channel from the specified key frame and start reproducing the decoded data when a time stamp is synchronized with a newest broadcasting time.

5. A mobile phone comprising:
the digital television broadcasting production device according to claim 1.

6. A digital television broadcasting reproduction method that enables a single display to reproduce a digital television broadcasting on a first channel and a simultaneous display to reproduce the digital television broadcasting on both the first channel and a second channel, said digital television broadcasting reproduction method comprising:
storing the encoded data of the second channel in an encoded buffer at the time of single display,
specifying, at time of a switching from the single display to the simultaneous display, a key frame which is a start frame for decoding in the encoded data of the second channel and has a time stamp, which is earlier than a broadcasting time at the time of the switching and also is closest to the broadcasting time at the time of the switching, and generating decoded data by decoding the encoded data of the second channel stored in said encoded buffer from the specified key frame, and
starting a reproduction of the decoded data when a time stamp is synchronized with a newest broadcasting time.
